(19) United States
(12) Patent Application Publication
(10) Pub. No.: US 2016/0185199 A1
(43) Pub. Date: Jun. 30, 2016

(54) SOLAR POWERED CAR COVER

(71) Applicant: Cynthia Cook, Saint Louis, MO (US)

(72) Inventor: Cynthia Cook, Saint Louis, MO (US)

(21) Appl. No.: 14/587,289

(22) Filed: Dec. 31, 2014

(51) Int. Cl. B60J 11/00; H02S 30/20

(52) U.S. Cl. CPC B60J 11/00; H02S 30/20

(57) ABSTRACT

A solar powered car cover that includes a three layer design, wherein a first layer includes a solar panel array; a series of heating elements that creates a second layer of the car cover; and a bottom layer that is placed under the heating elements for direct contact on a vehicle surface. The first layer may further include a battery pack, where the battery pack stores energy generated by the solar panel array and supplies power to the series of heating elements. The first layer may also include an on/off switch.

### BACKGROUND OF THE INVENTION

1. Field of Invention

The present invention relates solar powered cover for any surface of vehicle to reduce ice and snow buildup during winter months.

2. Description of Related Art

One of the drawbacks of the winter season relates to the additional work that may be necessary to operate a motor vehicle. Many people park their vehicles outdoors and as such the vehicle is subject to any conditions that may arise while parked outdoors. This exposure is particularly problematic during the winter months when snow and ice may accumulate at any time during the season. Many times ice and snow is formed on the hood, roof and windshields of the vehicle while parked outdoors. Before an individual is able to operate their vehicle they normally must remove snow or ice from the windows, hood, roof and trunk areas of the vehicle. The removal is normally required to access all features of the vehicle such as entry into the trunk or even entry into the doors may require some significant defrosting before use. As a consequence, it would be advantageous to have a warming cover that may be placed over a vehicle surface to prevent or decrease the likelihood of ice and snow forming over the motor vehicle.

### SUMMARY OF THE INVENTION

The present invention relates to a solar powered car cover that includes a three layer design, wherein a first layer includes a solar panel array; a series of heating elements that creates a second layer of the car cover; and a bottom layer that is placed under the heating elements for direct contact on a vehicle surface. The first layer may further include a battery pack, where the battery pack stores energy generated by the solar panel array and supplies power to the series of heating elements. The first layer may also include an on/off switch.

### BRIEF DESCRIPTION OF DRAWINGS

FIG. 1 depicts a solar car cover in accordance with the present invention.

### DETAILED DESCRIPTION

The present invention relates to a solar powered car cover that is used to place over an outside surface of a motor vehicle. The object of the car cover is to keep the outer surface of the vehicle warm and therefore decrease the likelihood of snow or ice accumulation in the winter season. The present invention is a multi-layered cover that may be substantially flat and rectangular in shape. The car cover includes a bottom layer that is placed directly on the surface of the motor vehicle, a middle layer that includes a series of heating elements and a top layer that includes a solar panel that collects energy from UV rays. Further on the side of the solar panel is a battery that is charged through the use of the solar panel. This battery provides power to the heating elements of the middle layer. The cover is a self-powered and efficient device that is placed directly over the surface of a vehicle during the winter months.

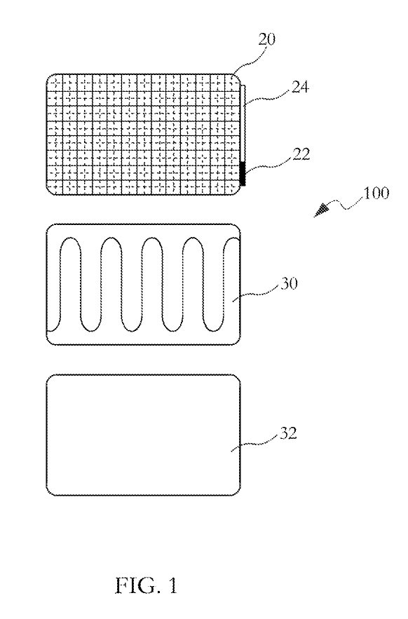

In reference to FIG. 1, a solar powered car cover 100 is depicted. A car cover 100 includes three layers. A top solar panel layer 20 is shown. The second layer is a series heating elements 30 and a bottom layer 32 includes a soft material that transfers heat from the heating elements 30 to the surface of the motor vehicle. The bottom layer 32 is placed directly onto the surface of the motor vehicle and receives heat from the heating elements 30. As depicted in FIG. 1, these layers are separated to provide an exploded view of the present invention. The solar panel layer 20 includes a battery pack 24 that stores energy generated through the use of the solar panel 20. The solar panel 20 is an UV collection plate that has a photovoltaic ray to receive UV rays in order to generate power for the battery 24. Further an on and off switch 22 is provided on one side of the panel 20. When the layers are fully connected the battery pack 24 provides power to the heating elements 30.

During use the user places the car cover 100 over an outside surface of the vehicle. Heat generated through the heating elements 30 transfers to the bottom layer 32 and therefore prevents the accumulation of ice and snow over the surface that receives the cover 100. Use of the present invention therefore limits the accumulation of snow and ice on the vehicle. The instant invention has been shown and described in what it considers to be the most practical and preferred embodiments. It is recognized, however, that departures may be made there from within the scope of the invention and that obvious modifications will occur to a person skilled in the art.

What is claimed is:

1. A solar powered car cover comprising;
a first layer, where the first layer includes a solar panel array;
a series of heating elements that creates a second layer of the car cover; and
a bottom layer that is placed under the heating elements for direct contact on a vehicle surface.

2. The solar powered car cover according to claim 1, where the first layer further includes a battery pack, where the battery pack stores energy generated by the solar panel array and supplies power to the series of heating elements.

3. The solar powered car cover according to claim 1, where the first layer further includes an on/off switch.
